(19) United States
(12) Patent Application Publication
(10) Pub. No.: US 2004/0047362 A1
(43) Pub. Date: Mar. 11, 2004

(54) Scalable scheduling method having, in particular, a spacing and retiming function during the dispatching from atm cells and a correspponding scheduling device therefor

(76) Inventors: Michael Menth, Oellingen (DE); Thomas Reim, Balzheim (DE); Matthias Schmid, Wurzburg (DE); Stefan Schneeberger, Vaterstetten (DE); Phouc Tran-Gia, Wurzburg (DE)

Correspondence Address: MORRISON & FOERSTER LLP, 1650 TYSONS BOULEVARD, SUITE 300, MCLEAN, VA, 22102, US

(21) Appl. No.: 10/399,173

(22) PCT Filed: Oct. 1, 2001
(86) PCT No.: PCT/DE01/03756

(30) Foreign Application Priority Data
Oct. 16, 2000 (DE) 100511465

(51) Int. Cl. H04L 12/56

(52) U.S. Cl. 370/412

(57) ABSTRACT

The invention relates to a method for determining an allocation time (NS) in a scheduler (9) with a fixed number (K) of allocation times, whereby a defined allocation time of the number of allocation times is determined for a time to be allocated using a hash function, and whereby the actual progression of time is represented on this fixed number (K) of allocation times also using the hash function. A method for determining a sending time (TST) for a data cell (13) over an output line (3) of a packet oriented transmission system, particularly in accordance with the ATM standard, is advantageous when a determined sending time (TST) is entered into a scheduler (9) as the time to be allocated for the data cell (13). This advantageously ensues by using the above-mentioned method. Additional areas of application are schedulers in machine installations, switching systems in, in particular, packet-oriented communications systems or multiplexers for multiplexing data.

### DESCRIPTION

Scalable scheduling method having, in particular, a spacing and retiming function during the dispatching of ATM cells and a corresponding scheduling device therefor

The invention relates to a scheduling method for the dispatch of ATM cells with the generic characteristics of claim 1 as well as a scheduling device therefor.

Wired communication systems or radio communication systems, for example the second-generation European mobile radio system GSM (Global System for Mobile communications) and the future radio communications system UMTS (Universal Mobile Telecommunication System) feature packet-oriented transmission of data, in which case the data is currently transported over ATM (ATM: Asynchronous Transfer Mode) lines. Since the use and the maintenance of such ATM lines is cost intensive, providers are attempting to utilize the available bandwidth to the maximum extent possible. To this end what is known as the ATM Adaptation Layer Type 2 (AAL2) protocol has been standardized as a multiplexing protocol, that in the case of voice connections for example uses a fixed ATM payload of 48 bytes while using short subscriber packets.

Since the average size of a currently normal speech packet is around 20 bytes, only around 40% of the usable load capacity of an ATM cell (48 bytes) is used. The known solution to this and similar problems is the multiplexing of a number of speech packets in a single ATM cell.

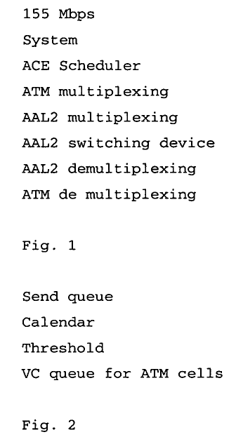

The current normal implementation of a connection device required for this is illustrated using FIG. 1.

In this device a first physical input line 1 leads into a connection device 2. Data that is routed via an input line 1 into connection device 2 is virtually converted in particular in this connection device or retimed and then output via a physical output line 3. Input line 1 and output line 3 are currently usually operated as 155 Mbps lines. Within connection device 2 incoming ATM cells are demultiplexed by an ATM demultiplexer 4 and forwarded to an AAL2 demultiplexer 5. The data is thus divided up between a large number of virtual connections and finally reassigned in an AAL2 switching device 6. From the switching device 6 the reassigned data is directed to an AAL2 multiplexer 7 and finally to an ATM multiplexer 8 which collects and prepares the cells for forwarding via physical output line 3.

A large number of virtual connections therefore arrive at switching device 6 for which the data must be accordingly distributed to suitable virtual output connections. Usually there is provision for buffering so that a certain quantity of data to be processed and arriving simultaneously can be stored in buffering devices. For the function of switching device 6 or the corresponding assignment of data that is arriving via the correspondingly many virtual connections to a correspondingly large number of outgoing virtual connections that must be multiplexed on one outgoing physical connection, what are known as traffic contracts are taken into consideration for handling the virtual connection. These system-specific traffic contracts ensure a required (QoS: Quality of Service) for a virtual connection. In particular these contracts ensure that only as much data traffic is let into switching device 6 as can be managed by the latter and especially by physical output line 3.

With this type of implementation specifications must first arrive via the individual connections that provide information about the maximum amount of data that is to arrive subsequently. For example in service category “(CBR: Constant Bit Rate)” a maximum data rate per connection (Peak Cell Rate (PCR)) and a Cell Delay variation tolerance (CDVT) are specified. A unit located in connection device 2 for monitoring the traffic contracts (policer) marks or deletes a cell if this does not correspond to the generic cell rate algorithm GCRA (1/PCR, CDVT). Marked cells can be deleted later if necessary on a preferential basis by another connection device.

To prevent this situation cells are processed delayed and spaced in time. This processing takes place in particular using algorithms that select cells located in buffers or queues for further processing. Algorithms for scheduling of a fixed send time however are associated either with respect to processing and selection options with great rigidity and with a very high computing overhead. Processing cells within a manageable time, in particular within a few cell cycles or system clocks is however not possible with these algorithms.

The task of the present invention is to propose a scheduling method for the dispatch of ATM cells as well as a suitable timing device therefor.

This task is handled by a method for determining an assignment time in a scheduler with the characteristics of claim 1 or a scheduler to execute a corresponding method in accordance with claim 15.

Independent inventive solutions can be found when using such a method in determining a dispatch time for a data cell in a packet-oriented transmission system in accordance with claim 9 and in schedulers, communications equipment and multiplexers in communications systems.

Advantageous embodiments are in particular also the object of dependent claims.

Advantageously the method used to determine an assignment time in a scheduler with a defined number of assignment times maps a time to be assigned by means of a function to a specific assignment time of the number of assignment times in each case. In this case the number of assignment times can be limited by this to a maximum number in such a way that the function maps the actual ongoing time to the defined maximum number of assignment times. For entry of an event or a reference to the event in a memory area of the scheduler corresponding to one of the assignment times, this memory area no longer has to be searched through up to this point.

The search for entered events in particular is arranged simply since a point in time searched for can be calculated directly with a simple function, especially a hash function, for example the modulus function. The result of the calculation then points directly into the memory space assigned to this time. In other words instead of using long, time-consuming search processes, data for a particular point in time can be assigned or found with a very small, clearly defined timing effort. This search only has to be made in the case Of a number of entries in one of the memory areas and this only has to be done in respect of the entries within this area.

Times to be assigned outside the currently assignable times and the associated events would in particular be assigned using a modulus function to an “incorrect” assignment time. In cases in which this is not to be excluded for system reasons or because of a sufficient number of assignment times, such times or the data belonging to them can be ignored and temporarily registered in a separate mapping area.

The number of assignment times or entry areas to be assigned to a memory area in each case provides the opportunity for entering data and/or reference information for data, programs and events into a memory area. Particularly advantageous is the entry of pointers to a data storage area so that the storage area of the scheduler and the storage area for data can be administered separately as regards system technology and/or construction

Data and reference information (16) for a number of times and events to be assigned can be entered in particular into the entry areas so that for each assignment time a number of events can be administered in a simple fashion. The data and reference information for a number of events can be stored in the same entry area particularly simply as a quantity, especially a list. In particular the use of pointers as elements of a double linked list enables simple reinsertion or removal or also the rearrangement of individual entries in a list of this type.

The method for determining a send time for a data cell over an output line of a packet-oriented transmission system, in particular in accordance with the ATM standard, can be executed simply and quickly by entering a specific send time as the time to be assigned for the data cell in a scheduler.

By using one of the items of reference information, in particular a pointer to point to a data cell and/or its memory location, it is possible to quickly enter events into the scheduler since the pointer information to be administered can be managed without any great effort.

If when determining the send time on the output line sufficient spacing of the data to be sent is adhered to, a specific traffic pattern can be created on the output line so that in communication systems with facilities that monitor the quantity of the data arriving and to be processed, the sorting out of data can be prevented for the case in which too much data arrives. This is especially advantageous when the transmission equipment looks for the origin of the arriving data and above a certain level of data density only excepts a specific quantity of data from the same source, since, with the present method, data from a different data sources can be mixed and appropriately spaced from one another or distributed over time in conjunction with a multiplexer.

Separate algorithms to establish a last send time and to determine a next possible send time allow a particularly flexible adaptation of this type of spacing mechanism to different requirements in respect of the traffic contracts for communications systems for example.

When determining the send time sufficient time for further processing of data, in particular multiplexing of data for the data cell(s) is to be provided, which will be especially simple to implement using the method described here.

The method used provides in an advantageous way a scalable scheduler with time specification functions combined with the multiplexing of the number of ATM connections, taking into consideration general timing conditions.

In an advantageous way such an algorithm can be implemented in a few hardware clock pulses. In particular such an algorithm or a such a device allows a cell to be entered for a specific desired time as the send time. Through the corresponding spacing the desired traffic pattern can be created at each of the output lines. This is worthwhile since otherwise data that does not conform to the traffic contract could be extracted by a subsequent monitoring equipment by policing. In addition, for the connections involved, this leads to an optimum fairness in resource allocation. The mechanism is scalable, can be implemented in a few cell cycles and needs no dynamic memory allocation. In particular there is also the opportunity of retiming so that cells can be relocated subsequently at another send time.

In an advantageous way a connection-individual forming or shaping is combined with the ATM multiplexing of a number of connections by spacing before the scheduling. The spacing is made possible by the fact that only one entry per connection is maintained in the scheduler. To allow retiming double linked lists with access addresses are maintained. Alternatively other ways of representing quantities for mapping memory space occupancy are also possible in which individual elements or pointers can be resolved.

At the heart of the scheduler is a calendar-type table which serves as a data structure for ATM cells for which a specific send request at some point in the future has been entered. The completed schedule is located in the final analysis in a send queue. Chained list structures allow a new timing for cells. The concurrent maintenance of spacing variables for individual virtual connections and a path, i.e. a group of virtual connections also allows the send request to be shifted to a point in time that is permitted in accordance with the corresponding traffic contract.

A corresponding switching facility provided that supports AAL2/ATM, can accordingly fulfill the following tasks. Data of an ATM line can be demultiplexed into individual virtual ATM Channel Connections (VCCs) and demultiplexed further into individual virtual AAL2 connections. After a reassignment of the real time data or data packets into new virtual AAL2 connections an AAL2 multiplexing is undertaken. In this the data is delayed for a maximum specified period (TCU) and up to ATM cell completion. For real time services under ATM send devices can be provided to fulfill the current traffic contract requirements that can space the cell stream or its data of a virtual ATM or channel connection in order to avoid loss of cells through sorting out by the policer of a subsequent connection device and such like. In the final analysis the ATM output is filled by ATM multiplexing.

In particular real time data for AAL2 multiplexing can be placed into queues in switching nodes and such like. Preferably with this type of AAL2 multiplexing the time of the cell spacing and of an ATM multiplexing delay in addition to a simple timer interval TCU for AAL2 multiplexing can be utilized in a single control device.

Advantageously this also makes possible a modular scheduling algorithm. A scalable scheduling system and a separate spacing algorithm leads to a scheduler that is also scalable as regards a large number of Virtual Channel Connections for data cells, makes an uncomplicated assignment or reassignment of specific send times possible and guarantees a cell spacing for secure forwarding of data.

In summary there a number of particular advantages that can be highlighted. In a single data device, in particular a data terminal the interworking of ATM and AAL2 is made possible with little effort as regards hardware implementation. Three required functions, AAL2 multiplexing, forming or spacing in accordance with the ATM traffic contract for the AAL2 path and ATM multiplexing of a large number of AAL2 paths are realized in a shared hardware device in a scalable manner. This makes it possible for the delay through cell spacing and ATM multiplexing to also be used for AAL2 multiplexing.

The modular structure of the algorithms makes it simple to convert the spacing function for AAL2 paths with CBR characteristics into some other type, e.g. tolerant path characteristics. The Architecture of the scheduler forms a basis in particular for further ATM applications. An expansion can for example lead in the direction of priority planning or a spacing based on virtual ATM path connections, whereby the favorable runtime features of the algorithms are retained.

In particular a transfer of the scalable scheduling mechanism to other technologies such as the Internet Protocol area, is possible, to support RTP/UDP/IP multiplexing in this area for example.

A multiplexing method with framework timing conditions becomes viable for the first time with the arrival of AAL2/ATM and technology for real-time data, which is why the problem definition did not exist earlier.

An exemplary embodiment is explained in more detail below with reference to the diagrams. The figures illustrate:

FIG. 1 a switching device in a physical line with underlying facilities for switching data packets or data cells;

FIG. 2 a scheduler with a large number of queues for virtual connections, a send queue and a calendar-type table;

FIG. 3 a double linked VCC list;

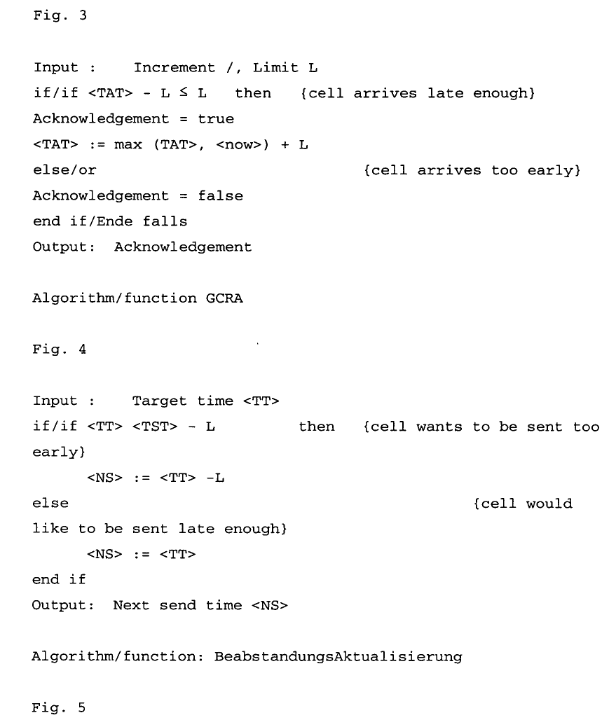

FIG. 4 a flowchart for a generic cell rate algorithm for monitoring the cell stream;

FIG. 5 a flowchart for an algorithm for defining a theoretical send time;

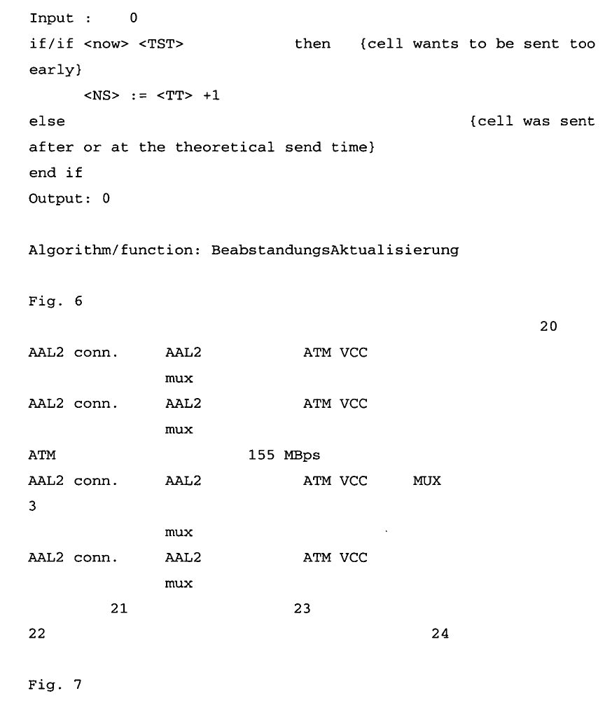

FIG. 6 a flowchart for an algorithm for updating a theoretical send time;

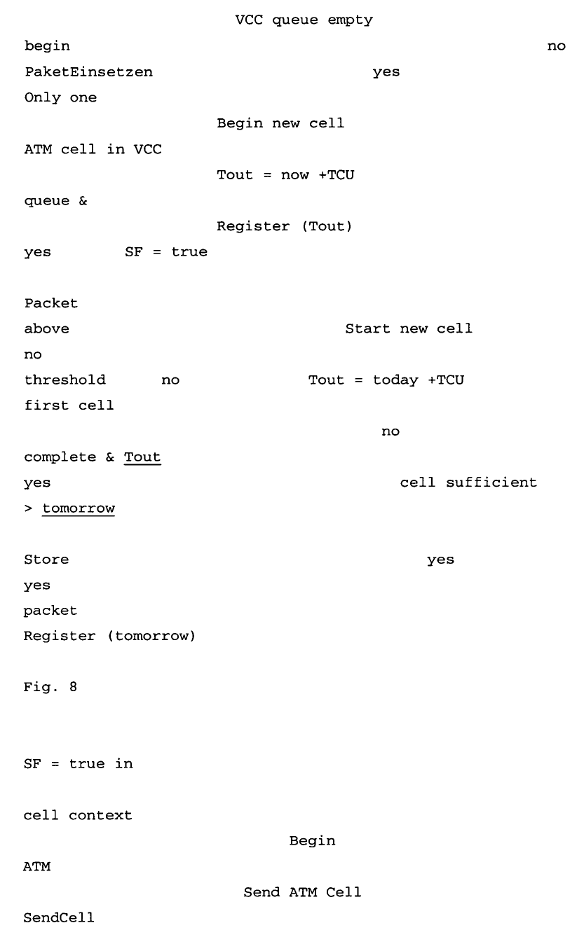

FIG. 7 an extract from an expanded scheduler for the AAL2 standard;

FIG. 8 a flowchart for an algorithm for entering data packets into a multiplexer of this scheduler and

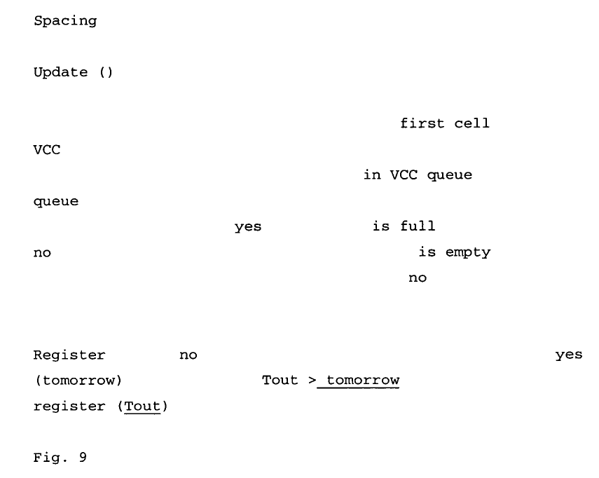

FIG. 9 a flowchart for an algorithm for output of data packets from this scheduler.

In a packet-oriented communication system or data network, in accordance with ATM for example, data is transmitted from stations to other stations. The data of a sending station is broken down into individual data packets or cells, sent in this way and reassembled at the receiving station. It is normal here for the data to be divided up with data of other connections of a shared transmission medium, known as physical connections, in particular wired lines. This data of different connections can be unpacked on the transmission route from its original cells and packed together with a data of other connections into new cells in order to optimize the utilization of the physical transmission paths.

Accordingly this data from such cells is taken out again at another location and finally used in cells or data packets that are transferred to the receiving station.

As can be seen from FIG. 1, connection devices 2 are provided for this purpose, for example the switches familiar from data networks. In this case there is at least one physical input line 1 that leads into a connection device 2. Data that is brought into connection device 2 via input line 1 is converted in this connection device or divided up again and then output via a physical output line 3. A number of lines can lead out from a switch or hub for example. Input line 1 and output line 3 are currently normally, but not necessarily configured as 155 Mbps lines. Within connection device 2 ATM cells arriving are demultiplexed by an ATM demultiplexer 4 and forwarded to an AAL2 demultiplexer 5. When this is done the data is divided up between a large number of virtual connections and finally reassigned in an AAL2 switching device 6. From switching device 6 the newly assigned data is routed to an AAL2 multiplexer 7 and finally to an ATM multiplexer 8 which combines and makes available corresponding cells for forwarding via physical output line 3. Apart from the buffering of the incoming data, all steps such as the demultiplexing take place purely virtually in a control cell.

A method is described below—typically for AAL2—in which the cells on this type of Virtual Channel Connection VCC are not assigned to a fixed time and time slot, as they are for example in a Time Division Multiplexing (TDM)system, but can be processed just as they arrive. The virtually spaced data are given an effective header section if necessary. This allows cells of different virtual channel connections and VCCs to contribute to a multiplexed ATM cell stream in the ATM output line. In particular more than the single ATM cell can be prepared at the same time for the ATM output and they are then forwarded in turn via output line 3.

In an advantageous embodiment a connection device 2 is connected to or equipped with a scheduler or time planner 9.

As can be seen from FIG. 2 an advantageous scheduler features a send queue (send queue 10), a table structured in the form of a calendar, referred to below as calendar 11 and a large number of queues of ATM cells for assignments for individual virtual connections and referred to below as VCC queues 12. The VCC queues 12 show individual cells for dispatch of the relevant VCC sections or VCC lines 1, 2, . . . N. For example VCC queue 1 features three cells 13 which are output at a later point in time via virtual connection 1 in the direction of multiplexers 7, 8. VCC queue 12 for the second virtual connection does not feature any data cells to be Output at the time shown. But since the cells remain in memory until the process is finished it preferably involves logical multiplexers 7, 8. VCC queue 12 for the third virtual connection in its turn features two cells to are to be output etc. In other words the data coming in via input line 1 into connection device 2 is broken down into a large number of VCC queues 12 to be output again later. In this case incoming data packets or cells can be forwarded directly unchanged to one of the VCC queues 12 or to one of the memory locations corresponding to this VCC queue 12. On the other hand it is also possible for the data coming into connection device 2 to be taken out of the original cells and redistributed, in which case this data is then assigned to the corresponding cells of one or more of the VCC queues 12. In the VCC queues 12 and/or the memory locations assigned to these in connection device 2, as with AAL2 for example, there is the choice of either using previously combined and transferred entire cells or also individual data, in which case individual data is then combined within VCC queues 12 to cells 13. Advantageously the devices described are logical devices and/or functions.

To use data in the VCC queues 12 or to empty or output cells 13 from these VCC queues the send queue 10 and the calendar 11 are used. For incoming data for example the system defines at which future point in time this is to be sent again. In this case data which is to be forwarded via a specific virtual connection is provided jointly as cell 13 in one of the VCC queues 12. An entry is made in calendar 11 from which the send time can be at least taken indirectly.

In send queue 10 a flag is set for the VCC queue which is to be the next to be provided for sending a cell 13. For this purpose a list is provided in send queue 10 with details of the order in which the VCC queues 12 are to output their cells in the corresponding virtual connections of multiplexers 7,8. With ATM for example a cell 13 is sent for each send cycle. These types of list with send instructions are also referred to below as VCC list 15. FIG. 3 shows such a VCC list 15.

Cells 13 are also output from the VCC queues in cycles in each case, in which case one of the VCC queues 12 outputs the first cell 13 located in it. In the procedure described below the key advantage is that only a few system clocks are required per cell cycle. As can be seen from FIGS. 2 and 3 the cell 13 located at the lowest point in the first VCC queue 12 is output in the first cell cycle, since the lowest or the first VCC list element of send queue 10 to be read out contains the value 1. Then this VCC list element 16 with the value 1 is removed from the VCC list 15 so that during the next read out cell cycle the cell 13 which is located at the lowest point is read out from the sixth VCC queue 12 since the corresponding value of VCC list element 16 is now “6”. With a third cell cycle cell 13 is correspondingly read out which is located in the 4th VCC queue 12 and is forwarded in the fourth virtual connection.

As can easily be seen, this means that each VCC queue 12 is assigned to at least one VCC list element 16, in which case the value of the VCC list element 16 points to the number of the corresponding assigned VCC queue 12. In other words the value of each VCC list element 16 points to an assigned VCC queue 12 or a memory location in the memory area assigned to this, in which the data or cells are buffered. From the programming standpoint the VCC list elements 16 thus have the function of a pointer to a memory location or memory area.

As can be seen from FIG. 2, there are three options for handling the VCC list elements 16. Thus in accordance with a first case, VCC list elements 16 with the values 1, 6 and 4 that are assigned to the first, sixth or fourth VCC queue 12 relief are inserted into send queue 10.

A second case arises in the situation of second VCC queue 12 in which there are no cells 13. The corresponding VCC element 16 with the value 2 does not exist at all or is at least not inserted into send queue 10 since in the next period no data from the second VCC queue 12 is to be output via the second virtual connection.

In the third case the VCC list elements 16 that belong to VCC queues 12 are inserted which, although they contain cells 13 for a later dispatch, the end date is still in the future for these cells. These corresponding VCC list elements 16 are accordingly inserted into calendar 11.

Calendar 11 consists in the preferred embodiment of an arrangement of calendar queues 17, in this case K, with for example K=4096 of such calendar queues 17.

With a less preferred embodiment each of these calendar queues exists for a desired output time or a desired output period, in which case the first assigned, nullth calendar queue 17 is taken into consideration first whereas those in the first calendar queue 17 are processed during a later period. At the latest when send queue 10 with this less preferred embodiment no longer contains any VCC list elements 16 or if its last VCC list element 16 was processed, the corresponding VCC 15 from the nullth calendar queue 17 is transferred into send queue 10. In the nullth calendar queue 17 that is now empty the first calendar queue 17 is now transferred in accordance with VCC list 15 etc. Alternatively a contiguous arrangement of queues can also be provided which each include VCC list 15. A pointer points in such a case to one of the queues which is then handled as send queue 10. After it has been processed the pointer is then the set to the next queue in this comprehensive queue arrangement so that this then functions as a send queue. In such a case however the assignment of new data or cells that arrive and for which the timing is to be rearranged is to be restructured accordingly.

This means that with this less preferred embodiment the first cells of the first, sixth and fourth VCC queue 12 in each case are read out, followed by the VCC list elements 16, in this case list element 16 with the value 10 transferred into send queue 10, so that subsequently the first cell from the 10th VCC queue 12 is read out. With the move of VCC list 15 from the nullth calendar queue 17 into send queue 10 or the subsequent move of VCC list 15 of the first calendar queue 17 into the nullth calendar queue 17, so that after processing of the VCC list element 16 with the value 10 from the send queue 10 the VCC list elements 16 with the values 7 and 3 then located in the nullth calendar queue 17 will be transferred into the send queue. Correspondingly in a third period in a first cell cycle the first cell from the seventh VCC queue 12 and thereafter in a second cell cycle of this third time period the first cell of the third VCC queue 12 will be output via the corresponding virtual connection.

Not shown in the present document but however technically feasible is also issuing a number of VCC list elements 16 per VCC queue 12. Thus for example for the three cells 13 that are located in the first VCC queue 12, accordingly three desired send times are flagged in send queue 10 or in calendar 11.

However for the particularly preferred embodiment each of the VCC queues 12 is only assigned a single VCC list element 16.

For an embodiment described below and particularly preferred the procedural timing as well as the use and/or conversion of VCC lists 15 or of their VCC list elements 16 is undertaken in send queue 10 and the calendar 11 or its calendar queues 17 with the help of time variables and the modulus function.

A particular advantage is obtained by using two separate functions that will be designated below as BeabstandungsAktualisierung (SpacingUpdate) (FIG. 6) or (NächsteBeabstandung) spacing next (FIG. 5) and will be used for updating the last send time or calculating the next send time of a virtual connection channel VCC for ATM in accordance with the traffic contract. This separation into different algorithms increases the adaptability to different systems and system conditions.

The use of the modulus function allows the implementation of the concept described below as what is known as a hash function or hash tables. In this a large number of arriving cells are each assigned a specific memory location through a hash function, in this case the modulus function. On the one hand this enables dynamic allocation of the memory space, on the other hand, to find a particular cell, it is not necessary to search through the entire memory for this cell since it can be quickly located again using the hash function, at least as regards the calendar queue.

In a typical ATM system the time is measured in cell cycles that are provided as transport units with a data scope of 53 bytes. A cell cycle for the typical transmission rate of 155 Mbps discussed here has a duration of 2.7 μsec. The start time can for example be selected as the time at which the operating system was started.

Absolute time values are represented below by data variables <datum> set in pointed brackets. Furthermore the variable <Today> is introduced below as a variable for the time of the current cell cycle and the variable <Tomorrow>=<Today>+1 as a variable for the cell cycle, that follows the current cell cycle <Today>. Where as the variables <Today> and <Tomorrow> originate here from a multiple of a discrete time unit and correspond to the duration of a “calendar interval” or express complete cell cycles, the other variables can assume any value in which case possible roundings and conversions can be undertaken. A variable <now> designates the current system time below.

These absolute time variables are incremented by 1 by the system automatically at the beginning of each cell cycle. The typical assumption made below for the scalable scheduling mechanism is that the scheduler 9 will be formed by a field with K columns, whereby these are sequentially numbered from 0 to K−1. The oldest item of data in the scheduler would then be <Tomorrow> and the youngest item of data would then be <Today>+K

As already set out by way of explanation the cells must satisfy a corresponding traffic contract. Among other things a specified spacing is required. Both the spacing and the monitoring can be undertaken on the basis of a circuit for Virtual Channel Connections (VCC).

A generic cell rate algorithm that is illustrated in FIG. 9 is used for monitoring the cell stream. This algorithm is called each time that a cell arrives in connection device 2. The arrival time of the cell always corresponds to the system time here, i.e. the data variable <now> that stands for the time since the last system start. A static variable <TAT> is the theoretical arrival time <TAT> (TAT: Theoretical Arrival Time) for the next cell. Each virtual ATM channel connection VCC is assigned a variable <TAT> here. If the next cell does not arrive earlier than the <TAT> in which case a certain tolerance L (Limit) is taken into consideration, the cell is handled as conforming with the generic cell rate algorithm GCRA(I, L), otherwise not. Depending on the system requirements as to how to react to these results, a cell that does not match is especially flagged with a bit for Cell Lost Priority (CLP) so that, in the event of forwarding problems in the connection device and later in the network, this cell can be held back in buffers and entirely deleted. In the service category “Constant Bit Rate (CBR)” for example a Peak Cell Rate (PCR) and Cell Delay Variation Tolerance (CDVT) are specified. The cell is marked accordingly if it does not correspond to the generic cell rate algorithm GCRA (1/PCR, CDVT) (GCRA: Generic Cell Rate Algorithm). For the known service category “real time Variable Bit Rate(rt-VBR) the Sustainable Bit Rate (SBR) and the Burst Tolerance (BT) are to be taken into account so that GCRA(l/SCR, CDVT+BT) would then be used.

The object of the spacing algorithm described below is to match the cell stream to the traffic contract. Thus the next possible send time <NS> must be calculated for this cell depending on a desired send time <TT> (TT: Target Time). The “NächsteBeabstandung” (“SpacingNext”) algorithm described in FIG. 5 can be used for this purpose. To find out whether a cell can be sent or not a theoretical send time <TST> similar to variable <TAT> is used in the cell rate algorithm GCRA.

If the target time <TT> is less than the theoretical send time <TST> minus the tolerance limit L, i.e. the cell might have been sent too early, the next send time <NS> is set to the next theoretical send time <TST> minus the tolerance limit L. Otherwise, if the cell might have been sent late enough , the next send time <NS> is set to the target time <TT>. Finally the next send time <NS> is output.

An algorithm for updating the theoretical send time <TST> needed here is shown in FIG. 6 and is subsequently designated as SpacingUpdate. Each time a cell was sent before the theoretical send time <TST> the theoretical send time <TST> is incremented by the value “I”. In the case of the traffic contract for the service “Constant Bit Rate” CBR the limit values here correspond to the cell delay variation tolerance CDVT and the inverse maximum data rate per connection (1/PCR), whereby I=1/PCR. If the cell is sent at or after the theoretical send time <TST>, the theoretical send time is determined from the send time <now> of the last cell plus the increment, i.e. <TST>=<now>+I.

The “NächsteBeabstandung” algorithm described on the basis of FIG. 5 is called to find out when a cell can be sent, which means before the cell is scheduled. The algorithm “BeabstandungsAktualisierung” will be called each time that a cell is sent, meaning when the planning result is met.

To ensure that the algorithms work correctly it is preferable to always only allow one cell per Virtual Channel Connection VCC to call the algorithms to determine the next send time <NS> since the algorithm NächsteBeabstandung is based on the value of the last theoretical send time <TST> that can only be calculated if the previous cell was sent.

Since the two algorithms NächsteBeabstandung and BeabstandungsAktualisierung can completely execute the spacing mechanism, it is easily possible to adapt these algorithms to have other functions executed, in particular it is possible to enable these to be adapted to other traffic contracts.

For the typical sequence in scheduler 9 described below a help data structure is also introduced for the Virtual Channel Connections. In particular where only one individual ATM circuit is taken into consideration for virtual Channel Connections (VCC) ATM cells 13 or references to their current storage locations must be stored in it, until they can be sent, usually at a later time. In general a delay must be taken into account here because of the cell composition, the spacing and the cell multiplexing. These functions can be executed without problems for as long as the data structures allow storage as in a First-In-First-Out (FIFO) queue.

Since the traffic contract is implemented for each circuit for Virtual Channel Connections VCC, the spacing is undertaken on a per-circuit basis for Virtual Channel Connections VCC. The spacing mechanisms described here serve this purpose in the case of a CBR traffic contract. The variables of the algorithms are largely fixed by the traffic contract here. In the present case these are the peak cell rate PCR and the cell delay variation tolerance CDVT. Furthermore the variable <TST> is stored per circuit for Virtual Channel Connections VCC.

A VCC queue that is largely full means a long delay for the ATM cells, something that cannot be tolerated in real-time operation. Thus a threshold can be specified for application purposes for the individual VCC queues 12 that determines a maximum number of ATM cells 13. Above the threshold the ATM cells 13 of the corresponding VCC queues 12 are no longer taken into consideration.

For the organization of an intelligent planning mechanism the VCC list elements 16 are advantageously provided as double linked lists for the Virtual Channel Connections or their VCC queues 12, as can also be seen from FIG. 3. In accordance with the preferred exemplary embodiment, for each VCC queue 12 a VCC list element 16, in particular precisely one VCC list element 16, is provided. Each of these VCC list elements 16 features a previously mentioned Virtual Connection Identifier (VCI) that is primarily a constant pointer to VCC queue 12 or to its storage location. As well as this each VCC list element 16 is assigned a next pointer 17 (next) and a previous pointer 18 (previous) whereby these point to the adjacent VCC list elements 16. For the particularly favored embodiments, in which the Virtual Channel Identifiers are not changed, this structure can be arranged to be particularly memory-efficient.

To set up a double-linked VCC list 15 a head pointer 19 and a tail pointer 20 are used. The head pointer 19 (head) points to any VCC list element 16, in particular to the first VCC list element to be processed within a VCC list 15. All except the last VCC list element 16 in the list point with their previous pointer 18 to VCC list element 16 which is the next to be processed. The last list element in the list points to the constant null that terminates VCC list 15. The same applies to tail pointer 20 (Tail) and the next pointer 17 of the VCC list elements 16 in the opposite direction.

A VCC list element 16′ is removed from the VCC list 15 as follows: The next pointer 17 or, in the case of the first VCC list element 16′, the head pointer 19 that points to this VCC list element 16 to be removed must be newly aligned to VCC list element 16″ to which the next pointer 17 of the VCC list element 16′ to be removed points. The same applies to the pointer in the opposite direction. In this way an individual VCC list element 16′ can be removed without great effort in a short and known-in-advance time. A particular advantage of this type of double linked list over a single linked list lies in the fact that in the case of a single linked list the pointers or the contents of many list elements are to be compared.

As regards the structures explained here the preferred scheduler 9 primarily consists of two different units. Calendar 11 holds future send requests from or for Virtual Channel Connections in the form of the addresses of VCC queue 12 that are assigned to these Virtual Channel Connections and cells 13 to be sent. Send queue 10 holds send requests for the cases of positive ATM multiplex delay or send requests for those VCC queues 12 for which the contents are to be transmitted in the very next cell cycles.

For each Virtual Channel Connection VCC or for the correspondingly assigned VCC queues 12 a specific cell cycle can be selected or reserved as next send time <NS> in which the next ATM cell 13 is to be sent out over this Virtual Channel Connection from VCC queue 12. The sequence of the type of cell cycles reserved for reading out the first cell from a VCC queue 12 in each case is entered in calendar 11. As regards the choice of term in the procedural steps described below, the term <Today> is again used for the current cell cycle and the term <Tomorrow> for cell cycle that follows it. The individual “days” thus correspond to the individual cell cycles that in the present exemplary embodiment have a duration of 2.7 seconds.

Assuming that no jobs will be issued for a reservation for a time later than K calculated from <Today> for a reservation, the result of a modulus mapping would be to set <NS> mod K equal to the column number or the calendar queue number in calendar 11. For a modulus mapping two numbers are divided, i.e. a first number divided by a second number, with floating point numbers being rounded to whole numbers, and a remainder from this division step is returned as a result, so that for example 19 mod 6,7 gives 5 as a result. Under this assumption a field with K columns is sufficient to represent all cell cycles that can be referenced. Calendar 11 thus comprises columns for the days <Tomorrow> up to an additional K days (<Today>+K−1).

In an advantageous way it is possible that a specific cell cycle is requested for more than a single Virtual Channel Connection than for this next possible send time <NS>. To enable this calendar 11 assigns a field with L areas in which not only an individual VCC list element 16 but a VCC list 15 can be stored, as can be seen from FIG. 2. The double linked VCC lists 15 in their turn contain a large number of VCC list elements 16 that each represent a VCC queue 12.

In accordance with a preferred embodiment two cases are considered for the assignment of a desired send time for a cell 13, which is arranged in a VCC queue 12. In the first case the desired send time lies in the past and before the current cell or send cycle. Then the corresponding VCC list element 16 assigned to the VCC queue 12 is entered directly into send queue 10. In the second case a desired send time is requested for a future point or send cycle. Then the VCC list element assigned to this VCC queue 12 is entered into one of the columns of calendar 11. For the assignment of a column it is preferable to use the modulus mapping described here. Where there is already a VCC list element 16 in the corresponding queues, that is in a send queue 10 and the corresponding calendar queue 17, this inserted VCC list element 16 is doubly linked with the VCC list elements 16 in the manner described here.

Such an arrangement of the VCC queues 12, the send queue 10 and the calendar 11 with the calendar queues 17 allows a functional interoperation of the kind in which the spacing functions and the ATM multiplexing can be performed in a very short time.

When a send request is output from or for a VCC queue 12 for a specific point in time or a specific date <TT> and such a request arrives from a control facility of scheduler 9 or a system control facility, the earliest possible send date is calculated with the aid of the algorithm shown in FIG. 5, whereby for the next send time <NS> the following applies <NS>=NächsteBeabstandung (<TT>). Instead of the origination and checking of a timer for this event the corresponding date or the corresponding timer send area is entered into calendar 11. A corresponding function to execute these steps and to register them (<TT>) is identified below. Accordingly this is entered in the VCC list element 16 assigned to VCC queue 12 and is entered in calendar 11 in the column which is calculated from <NS> mod L. For requesting a specific cell cycle <TT> for example this program function register(<TT>) can be used. This involves a normal programming function which investigates whether for target time <TT> a cell cycle can be ordered. Here the spacing gives the next send time at which the corresponding list element is to be entered into calendar 11.

For the exemplary embodiment shown each VCC queue 12 is only assigned a single VCC list element 16 so that individual VCC queues 12, for example the first VCC queue 12, have open, i.e. non-assigned send requests for further cells 13. This is a consequence of the sequence described using FIG. 4 and 5 and attributed to two algorithms NächsteBeabstandung or BeabstandungsAktualisierung.

There are simple alternatives for inserting a VCC list element 16 in a double linked VCC list. The insertion of a VCC list element 16 at the start leads to a last-in, first-out instruction (LIFO) in this VCC list 15 in the send queue 10 whereas the appending of this a VCC list element 16 at the end leads to a first-in, first-out sequence (FIFO) for the processing of the individual VCC list elements 16 of this VCC list 15.

For a virtual ATM or channel connection VCC with high or maximum data rate per connection PCR, i.e. with a large bandwidth, its next set send cell cycle is nearer in the future than for a virtual ATM Channel connection VCC with a low and minimal data rate per connection PCR. Thus a cell cycle through a virtual ATM Channel connection VCC with a lower data rate per connection PCR is more required than by a virtual ATM Channel connection VCC with a higher data rate per connection PCR. In other words for fast connections the cell spacing is very small and consequentially there is a greater effect of a change of send time compared to slow connections for which the send time shifts are less relevant. Looking at a fair allocation of resources virtual ATM Channel Connections VCC can thus be prioritized with a higher data rate per connection PCR compared to virtual ATM channel connections VCC with lower data rate per connection PCR, since this is more influenced by the same absolute ATM multiplexing jitter. Accordingly the appending of VCC list elements at the start of the VCC lists 15 in calendar 11 is preferred.

At the end of a cell cycle the VCC list elements 16 that are registered for the next cell cycle the next cell section, that is for <Tomorrow>, are transferred from first calendar queues 17 of calendar 11 into send queue 10. This removes the double linked VCC list 15 at the point <Tomorrow+l mod L> from calendar 11 and appends it to the end of the double linked VCC list 15 of send queue 10.

At the beginning of each cell cycle a number of actions are performed. The first is to increment the system variables for the current and the next “day”<Today> or <Tomorrow> by one. Then the potential sending of an ATM cell 13 is prepared and initiated. To this end the first VCC list element 16 is removed from send queue 10 and the corresponding VCC queue 12 is triggered in order to send out its next cell 13. To protect this cell from any changes within the corresponding cell cycle a send flag <SF> (SF: Send Flag) is set within the cell context. The spacing variable for the theoretical send time <TST> for this VCC queue 12 is also updated and this is done by calling the spacing procedure described here BeabstandungsAktualisierung( ). If the VCC queue 12 is not yet empty, as for example would be the case for the first VCC queue 12 after reading out of the lowest cell 13, the VCC list element 16 of this VCC queue 12 and one of the calendar queues 17 is used, and this is done by ordering a cell cycle for the next cell 13 in VCC queue 12.

In an advantageous way this system also allows a rearrangement of a VCC list element 16. An existing send request can be removed by simply removing the corresponding VCC list element 16 from calendar 11 or send queue 10. Through the arrangement with double linked VCC lists 15 this is done very quickly using the procedure described here, in which case no distinction is to be made between VCC list elements 16 in send queue 10 and a calendar queue 17 of calendar 11. Changing an existing send request for a VCC queue 12 can accordingly be implemented simply by removing its VCC list element 16 and renewed use of this VCC list element 16 for the new target time. Such a procedure can for example by performed by a Reregister(<TT>) algorithm. Like algorithm Register (<TT>) such an algorithm releases a VCC list element 16 from its structure and rearranges it, as with the registration algorithm, at a suitable point.

The execution time of all these processes is constant. In particular the execution time is independent of the number of Virtual Channel Connections VCC. The overall runtime of the algorithm depends on how often one cell cycle is requested for one of the VCC queues 12 and how often such a request is to be changed.

The simple structure of the scheduler 9 described does in particular allow scalability for ATM, whereby the runtime is independent of the number of VCC queues, it can be used with a few cell cycles and no dynamic memory allocation has to be undertaken. Advantageously only precisely determined pointer realignments have to be undertaken for switching over VCC list elements. Furthermore a simple spacing or option will be provided whereby VCCs undertaken conform with the peak cell rate (PCR) and the spacing creates a fairness between the VCCs. A further particular advantage is in the issuing of desired timing, in particular the approval of a send request for an absolute time and where this is in any way possible by a timer function. Finally the changing of the send time (retiming) is possible. Over and above this there are a large number of possible expansions.

For a transmission on other communication systems appropriate modifications are to be undertaken. Thus, for example in the Internet Protocol area, other clock divisions must be used instead of the cell cycles described here. Multi-dimensional memory areas can also be used instead of the single-column calendar queues.

A particular embodiment of a connection device for the AAL2 standard is described below that builds on the previously described planner and in particular can also be designated the ACE Planer (ACE: AAL2 Connecting Element) in order to distinguish it more easily. For this purpose a brief introduction into Asynchronous Transmission Mode (ATM) is described beforehand. Furthermore the scenario for an AAL2 planner 9 is specified from which the requirements are derived.

In ATM networks with the asynchronous transmission mode cells feature a fixed payload size of 48 bytes and an information header section or information header with a size of 5 bytes. This is a connection-oriented process whereby a Virtual Channel Connection (VCC) is used to transport data. The bandwidth is divided between the various VCCs by asynchronous multiplexing of the ATM cells that belong to different VCCs. This means that the VCC queues or the Virtual Channel Connections assigned to them are not assigned any particular time slot as would be the case for a system with a time Division Multiple Access (TDMA) whereby the cells are sent as soon as they arrive. It is thus possible that more than one VCC for sending a cell with the same time is only to be allowed for the administration of a VCC queue 12. This means that other VCC queues 12 are waiting for the sending of a cell 13 at the same time, whereby only one cell 13 can be transmitted. The result of this is that the cells 13 of the other VCCs must be delayed in time, which leads to an ATM multiplex delay. This task is performed by a scheduler 9 that executes send instructions to the virtual channel connections VCC.

Multiplexing any number of voice data into groups or samples in an ATM cell is known, particularly from the standardized protocol AAL2. To this end the voice samples are equipped with a 3-byte header which includes such items as the connection Identifier(CID) and the Lengths Indicator (LI). The voice packets including the AAL2 packet header are together generally designated as the CommonPartSublayer (CPS) packets.

Described below is an exemplary embodiment, on the basis of FIG. 7, of an ACE scheduler 9 that executes multiplexing in accordance with this AAL2 standard.

A large number of virtual channel connections lead into the ACE scheduler 20 here as AAL2 connections 21. Within the ACE scheduler 20 each of the AAL2 connections 21 is assigned to an ATM VCC queue 22 in which case these ATM VCC queues 22 each have a downstream AAL2 multiplexer 23. Finally the cells of the ATM or VCC queue 22 are multiplexed into an ATM multiplexer 24 and output on a physical output line, preferably operating at 155 Mbps. This too is effectively a virtual setup.

Since all possible sources of delay, i.e. a certain required multiplex time TCU, spacing and ATM multiplex delay are to be taken into consideration and utilized for the AAL2 multiplexing, the filling of a new ATM cell is only begun if the older cells are completely filled and if they are in the send process and an appropriate send flag <SF> set. Thus in a VCC queue 22 all except for the youngest ATM cell are filled. For AAL2 multiplexing the multiplex time TCU is specified in real time for each Virtual Channel Connection 21. Since the youngest ATM cell is filled, only one variable <Tout> is used per Virtual Channel Connection 21 to indicate when the multiplex process has lasted too long. To fulfill all these requirements the multiplexer or the multiplex facility are integrated advantageously into the planning mechanism. The VCC queues are also expanded by a number of AAL2 capabilities compared to those described previously.

When an AAL2 packet arrives the function PaketEinsetzen (UsePacket) is called, as can be seen from a flowchart in FIG. 8. After the beginning of the PaketEinsetzen function execution continues to a check as to whether the packet, in particular CPS packet, exceeds the limit as regards size. If it does, the packet is excluded from further processing and the function PaketEinsetzen is ended. If it does not, a next step checks whether the VCC queue is empty or not. If it is, a new cell is constructed whereby the variable <Tout> is set as equal to the sum of the variable <now> plus the variable for the multiplex time I. Subsequently a registration function to use or enter this cell into calendar 11 is called which is referred to here as function Register(<Tout>). Following on from this the function PaketEinsetzen is ended.

If the VCC queue is not empty a further check is made as to whether there is only one cell in the VCC and the send flag <SF> is set or is true. If it is, the function to set up a new cell is called again and subsequently the function PaketEinsetzen is ended. If the last condition mentioned above is not true a further request is made as to whether the first cell is complete and whether the variable <Tout> for this Virtual Channel Connection or VCC queue is greater than the value of the current cell cycle <now>. If yes, a rearrangement is performed which has already been described here as Reregister(<Tomorrow>) and includes removal of the old entry. After this rearrangement for the next data value or in the event of no response to the last request the program sequence continues to a further inquiry to check whether there is sufficient free space in the ATM cell. If there is sufficient space the function PaketEinsetzen is concluded. If the free space in the last ATM cell is not sufficient to accept the data of this incoming AAL2 packet a new cell must be created, in which case it is a formed in accordance with the variable <Tout>, again as the sum of the variable <now> for the instantaneous cell cycle and the variable TCU for the required multiplexing time.

The points to be highlighted in this function are that in cases of setting up a new cell the whole packet must be started to be put into this cell if the available VCC queue 22 is empty and if there is only one ATM cell in it, for which the send flag <SF> is set, i.e. a cell that is just being sent. In these cases the variable <Tout> as the sum of the instantaneous time value or cell cycle <now> and the multiplexing time required TCU are updated, after which the ATM cell is registered in calendar 11 for the time <Tout>.

Another case to be highlighted is that in which the first cell is sufficiently filled or is completed by accepting the new packet und this time for multiplexing is not yet reached, i.e. the variable <Tout> is greater than the instantaneous time value <now> In this case, for example by calling the Reregister function at the list element of the ATM cell is removed from calendar 11 and is registered for the next cell cycle <Tomorrow> with the Register function which takes account of the spacing so that sending can be performed in the next cell cycle. If the last ATM cell is not sufficient or there is not sufficient space available a new cell must be provided and the variable for the desired send time <Tout> is updated accordingly.

The sending of an ATM cell using the flowchart in FIG. 9 is described below, in which case a corresponding function is designated as ATM-ZellSenden (Send ATM cell).

In accordance with the basic embodiments of this type of scheduler 9 described here an ATM cell 13 is sent at the beginning of a cell cycle if there is a corresponding VCC list element 16 in send queue 10. At the beginning of the send process the VCC list element is removed from send queue 10, cell 13 of the corresponding VCC queue 12/22 is triggered for sending and the spacing variable of this Virtual Channel Connection or the assigned VCC queue 12 is updated. In addition the next cell 13 in calendar 11 is used and this is done using the function BeabstandungsAktualisierung( ) (SpacingUpdate( )). Because of the time restrictions that arise through multiplexing in accordance with AAL2, this procedure must be refined.

As can be seen from FIG. 9, a block is set in function ATM-ZelleSenden (Send ATM cell) after it begins so that no further multiplexing is undertaken. To avoid inconsistencies with regard to the read/write problem, i.e. collisions and through simultaneous read and write accesses to a memory area, the send flag <SF> is set in the cell context. The sending of the cell is then initiated and the function BeabstandungsAktualisierung( )is called in order to update the Virtual Channel Connection of its <TST> variable.

In the next execution step a check is made as to whether the VCC queue is empty or not. If it is empty, the ATM-ZelleSenden function is ended since there are no cells present to be sent. If the VCC queue is not empty a check is made as to whether the first cell in this VCC is full or not.

If the first cell in a VCC queue is already full and its time has expired then the function or the subprogram Registriere(<Tomorrow>) is called so that for this VCC queue the next “tomorrow” cell cycle is arranged. Otherwise the cell is entered into calendar 11 with a desired output time for sending or a desired target output time for sending <Tout>. To this end a comparison is again undertaken as to whether the variable value of the output time <Tout> used is greater than the <Tomorrow> time value or not. Depending on this, the function Registriere(<Tout>) or the function Registriere(<Tomorrow>) are called, after which the function ATM-ZelleSenden is ended.

In summary the following can be said for this ACE scheduler described here: On the input side AAL2 packets reach the scheduler via one and more AAL2 packet input streams in which case a number of AAL2 paths can be used. On the output side one and more ATM cell streams are preferably applied to an output line. Both the AAL2 multiplexing, the spacing and also ATM multiplexing are integrated. Building on the basic concepts of the advantageous scheduler described in the introduction, ATM multiplexing takes place here through the previously described scheduler, AAL2-multiplexing takes place however in the queues of the Virtual Channel Connections. A number of AAL2 packets are multiplexed in an ATM cell, in which case the scheduler limits the maximum multiplexing time. Scheduling is also undertaken that supports spacing and AAL2 multiplexing for the ATM multiplexing per cell cycle. In this case ATM cells can be ready for sending in a number of VCC queues whereby however only one Virtual Channel Connection or its queues send an ATM cell at the same time. In addition spacing is undertaken, in which case it is ensured that for each Virtual Channel Connection the traffic contract is adhered to, this in particular with regard to PCR and CDVT. With the appropriate controls a concept can be implemented for the assignment of send times in which a fair distribution is ensured. Overall this approach offers throughput maximization of the entire component or of the entire connection device. It exhibits a particular advantage in real time processing and practically real-time processing.

In particular spacing is undertaken since other network nodes perform monitoring or policing at a later time and data which follows too densely there could be deleted.

1. Procedure to determine an assignment time (NS) in a scheduler (9) with a fixed number (K) of assignment times,
whereby for a time to be assigned a specific assignment time of the number of assignment times is determined in each case by a function and
whereby by means of this function the actual accumulated time is mapped to this defined number (K) of assignment times.

2. Method according to claim 1, in which a hash function, in particular a modulus function, is used as the function.

3. Method according to claim 1 or 2, in which times to be assigned outside the times that can be assigned at this moment and the associated events are ignored and/or registered temporarily in a separate mapping area.

4. Method according to an existing claim, in which the number (K) of assignment time entry areas (10, 17) are assigned in a memory space whereby data and/or reference information to data programs and events are entered directly in the entry areas (10, 17).

5. Method according to claim 4, in which data and reference information (16) for no, one or a number of assigned times and events are entered into the entry areas (10, 17):

6. Method according to claim 4 or 5, in which data and reference information for a number of events are entered into the same entry area (10, 17) stored in each case as a quantity, in particular a list (15).

7. Method according to claim 6, in which the quantity (quantities) are constructed from a sequence of double linked reference information (16).

8. Method according to one of the claims 4-7, In which data and or reference information entered into one of the entry areas (10, 17) can be removed again and/or rearranged into another entry area (10, 17) corresponding to another assignment time.

9. Method for determining a send time (TST) for a data cell (13) over an output line (3) of a packet-oriented transmission system, in particular in accordance with the ATM standard, characterized by
entry of at least one specific send time (TST) as a time to be assigned for the data cell (13) in a scheduler (9), in particular using a method in accordance with one of the existing claims.

10. Method according to one of the claims 4-8 and claim 9, in which
with one of the items of reference information (16) a reference is made to a data cell (13) and/ or its storage location.

11. Method according to claim 9 or 10, in which on determining the send time (TST) a suitable spacing of the data to be sent is adhered to on the output line (3), in particular to create a specific traffic pattern on the output line (3).

12. Method according to one of the claims 9 to 11, in which the separate algorithms to establish a last send time (BeabstandungsAktualisiereung< . . . >) and to determine a next possible send time (NächsteBeabstandung< . . . > are used.

13. Method according to one of the claims 9 to 12, in which for determining the send time sufficient time for a further processing of data, in particular multiplexing of data for the data cell(s) (13) is provided.

14. Scheduler for performing a procedure in accordance with one of the claims 1 to 13.

15. Scheduler according to claim 14 with
fixed number of memory areas to which a maximum fixed number of assignment times are allocated and
an allocation facility that allocates the times and references to be assigned to the associated data for the assignment times.

16. Switching device in a communication system, in particular packet-oriented telecommunications system or data network, with a scheduler in accordance with claim 14 or 15.

17. Multiplexer for multiplexing data with a scheduler in accordance with claim 14 or 15 and/or a switching device in accordance with claim 16.
